(19) United States
(12) Patent Application Publication
(10) Pub. No.: US 2008/0032628 A1
(43) Pub. Date: Feb. 7, 2008

(54) Method and apparatus for detecting trends in received signal strength

(75) Inventors: Pekko Vehvilainen, Tampere (FI); Mikko Jaakkola, Lempaala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/499,399

(22) Filed: Aug. 2, 2006

(51) Int. Cl. H04B 7/00; H04Q 7/20

(52) U.S. Cl. 455/41.2; 455/436

(57) ABSTRACT

The present invention provides a new and unique method and apparatus for detecting in a short-range communication device, such as a WLAN station (STA), the trend in WLAN signal strength based on one or more characteristics, e.g. received signal strength values and current time of their observation, by fitting a generalized linear model to the values. Based on the detected trend, three things can be inferred: 1) WLAN radio coverage available for STA is strengthening, 2) WLAN radio coverage available for STA is stationary, or 3) WLAN radio coverage available for STA is weakening.

### BACKGROUND OF THE INVENTION

1. Field of Invention

The present invention related to a method and apparatus for detecting trends in received signal strength in a wireless local area network (WLAN) or other suitable wireless short-range communication networks. Moreover, the present invention relates to handovers in a wireless short-range communication environment, and more particularly provides a method and system for a mobile station to detect trends in received signal strengths to provide an enhanced system for predicting when a handover event is really needed to prevent unnecessary handover events and at the same time enabling the mobile station to prepare for an upcoming handover.

2. Description of Related Art

User experience for wireless short-range communication network, such as, for example WLAN coverage and usability is dependent on several things, namely, the physical environment (free space, open office, closed office, etc.), 802.11 physical layer (user equipment and network configuration), radio media traffic congestion and disturbances, user movement within WLAN coverage area, user application data transfer rate need, and so forth.

According to current WLAN implementation, handovers (HO) within infrastructure are based on generally two occasions:

1) signal level drops below certain received signal strength indicator (RSSI) level, or

2) certain number of packets are lost.

As the current WLAN implementation does not provide any kind of means to predict whether the WLAN link loss is a result from an actual event where the mobile station reaches the boundary of the WLAN access points coverage wherein a handover is needed, the current implementation results in situations where mobile stations continually make handovers which causes unnecessary power consumption and traffic in the network, which could be avoided with careful planning. Further, as the mobile station cannot make estimations whether a handover would be needed based on the trend of the signal level, the handover process is not that smooth.

Frequently, it can happen that the WLAN data link can be lost either abruptly or gradually. In such occasions, the data link needs to be handed over to another access point (AP) in hope of a better connection quality. Handover can be either vertical (between systems like in UMA (WLAN) to GSM handover) or horizontal (WLAN BSS to BSS handover), but for both vertical and horizontal HOs it would be beneficial for the user if the need for the handover could be predicted before the link is lost or data transfer is impaired unnecessarily.

Using raw signal values without any filtering for predicting the signal levels can cause unnecessary scan requests to the WLAN subsystem thus increasing power-consumption and, in the case of active scan, increases the WLAN network load.

In particular, at present there is no method for predicting WLAN link loss. HOs are initiated in known WLAN software (SW) on two occasions:
1. When the signal level drops below a certain RSSI level. The HO threshold value can be configured individually for vertical and horizontal HOs.
2. When a certain number of transmitted packets are lost. The threshold of lost packets before HO is initiated can be configured before a link loss indication is given.
   Currently, the link loss indication is given when the signal strength measurement falls below a given threshold value (say, −80 dBm). Because the measurements are currently not filtered in any way it can cause unnecessary link loss indications and HOs in situations where there is a separate event (one bad or missing measurement) that can trigger the link loss indication. Another disadvantage of relying on a single link loss triggering threshold is that the threshold has to be set in a way so that there is time to do the HO when the radio coverage is degrading.

When considering related techniques in the prior art, there are known solutions for estimating handovers in cellular networks.

For example, one known technique includes a type of handoff algorithm for estimating suitable handoff time in the WLAN software by using a least square equation for processing received signal strength values. However, the proposed Grey prediction algorithm is a very complex algorithm.

U.S. Pat. No. 6,006,077 discloses received signal strength determination methods and systems, where a signal strength for a received signal such as a radio signal transmitted over a communication network is determined. The signal strength measurement is compensated for non-linear characteristics of the receiver. The compensation is provided by taking two signal strength readings with the receiver set at two different, known, gain levels. The difference between the expected change in the signal strength and the change actually measured by the receiver is used to generate a compensated signal strength measurement A table of compensation factors is generated for each signal strength which is also utilized in generating the compensated signal strength measurement. The compensated signal strength measurement reading is transmitted to the communication network for use in mobile assisted handover.

U.S. Pat. No. 5,845,208, assigned to the assignee of the present application, discloses a receiver and a method for estimating received power in a cellular radio system having in each cell at least one base station communicating with mobile stations within its coverage area. The mobile stations measure strength of the signal received from a base station, and report the measurement results to that base station. To improve power adjustment, a model describing the dynamic behavior of the signal is created for the received power on each connection. The model is utilized for power adjustment, as well as for making handover decisions.

In summary, the aforementioned cellular network handover systems do not include at least the following two points:

1) calculation/estimation is not done solely in the mobile station without receiving any assistance from the network side.

2) calculation/estimation is not done for every received packet “automatically”, so there is not a large set of input data to allow using a different type of algorithms to define the trend of the received signal strength.

### SUMMARY OF THE INVENTION

In its broadest sense, the present invention provides a new and unique method and apparatus for receiving signals from a node, point or terminal in a wireless short-range communication network and estimating in a short-range communication device a trend in one or more characteristics related to the received signals that can be utilized to predict a reliable threshold for performing a handover.

In one particular embodiment, the method and apparatus provide for detecting in a WLAN station (STA) the trend in WLAN signal strength based on one or more characteristics, e.g. received signal strength values and current time of their observation, by fitting a generalized linear model to the values. Based on the detected trend, three things can be inferred:

1) WLAN radio coverage available for the STA is strengthening,

2) WLAN radio coverage available for the STA is stationary, or

3) WLAN radio coverage available for the STA is weakening.

In operation, the technique includes receiving signals from a node, point or terminal (such as an access point (AP)) in the wireless local area network (WLAN); and estimating in the WLAN station (STA) a trend in the received signal strength values and the current time of their observation related to the received signals that can be utilized to predict a reliable threshold for performing a handover. In effect, given current time and signal strength, the technique can be utilized to predict the threshold for a handover (HO).

In effect, a solution is provided so that the mobile station could make calculations to determine the trend of the signal strength by way of calculating a trend estimation using the signal strength of each received packet as input data. With this information, the mobile station has a way to substantially reliably define whether there is actually a need to make a handover or not.

The actual calculations and algorithm for determining the estimation of the trend of the signal strength are based on performing median filtering for each measured signal strengths in order to level the values to keep them more “in-line” by reducing significance of a particular measurement value for the estimation. Then, a linear regression curve is created based on the results of least square estimation of the median filtering results, wherein the resulting “graph” indicates longer lasting step-like results that indicate the trend based on the measurements.

The median filtering and least square estimation are as such already known concepts, but there is also a difference between the approach according to the present invention (due to the WLAN environment) the signal level can be done for each received packet which allows this type of levelling of the received signal strengths while ensuring that in case of detecting dropping signal levels, the handover estimation can be done without a substantial delay.

In effect, there are distinctive features between the present invention and the known cellular network handover systems that include at least the following points:

1) calculation/estimation is done solely in the mobile station without receiving any assistance from the network side, and

2) calculation/estimation is done for every received packet “automatically”, which provides a large set of input data that allows using a different type of algorithms to define the trend of the received signal strength.

The method further includes implementing the step thereof via a computer program running in a processor, controller or other suitable module in the WLAN STA.

The apparatus may take the form of a system having a node, point or terminal for providing signals in such a wireless local area network (WLAN) and a WLAN station (STA) having one or more modules configured for receiving signals and estimating the trend in the one or more characteristics, including the received signal strength values and current time of their observation, related to the signals that can be utilized to predict the reliable threshold for performing the handover.

The apparatus may also take the form of a terminal, including in such a station (STA) in such a wireless local area network (WLAN), the terminal having a first module configured for receiving signals from the node, point or terminal in the wireless local area network (WLAN); and a second module for estimating the trend in the one or more characteristics, including the received signal strength values and current time of their observation, related to the received signals that can be utilized to predict the reliable threshold for performing the handover.

The apparatus may take the form of a computer program product with a program code, which program code is stored on a machine readable carrier, for carrying out the steps of a method comprising receiving signals from the node in the wireless local area network (WLAN) and estimating the trend in the one or more characteristics, including the received signal strength values and current time of their observation, related to the received signals that can be utilized to predict the reliable threshold for performing the handover, when the computer program is run in a module of a node, point or terminal, such as in a WLAN station (STA).

In summary, the basic idea of this invention is to provide a simple calculation algorithm for determining the estimation of the trend of received signal strengths based on each received packet. The calculation is based on performing median filtering for signal strengths of each received packet and creating a linear regression curve based on results of least square estimation of the median filtering results, wherein the resulting “graph” indicates longer lasting step-like results that indicate the trend of the signal strengths based on the measurements. The terminal can then use the results of the calculations to perform handovers more efficiently.

### BRIEF DESCRIPTION OF THE DRAWING

The drawing includes the following Figures, which are not necessarily drawn to scale:

FIG. 1 shows an exemplary IEEE 802.11 WLAN system in which the principles of the present invention are applicable.

FIG. 1A shows an exemplary extended service set (ESS) with a wired distribution system (DS) in which the principles of the present invention are also applicable.

FIG. 1B shows 802.11 WLAN (horizontal) handoff (HO) scenarios according to one embodiment of the present invention.

FIG. 1C shows an Unlicensed Medium Access (Vertical) handoff according to one embodiment of the present invention.

FIG. 2 shows a flowchart of the basic steps of the method according to one embodiment of the present invention.

FIG. 3 shows a block diagram of the basic modules for a station (STA) according to various embodiments of the present invention.

FIG. 4 shows a more detailed flowchart of a method for detecting trends in WLAN signal strength according to one embodiment of the present invention.

FIG. 5 shows an example of a least squares estimator line fitting that may be used to implement the present invention.

FIG. 6 shows an example of a structure of a median filter that may be used to implement the present invention.

FIG. 7 shows an example of the affects of a median filter on three different waveforms.

FIGS. 8-10 shows simulated data for a handoff prediction based on the use of the present invention.

FIGS. 11a and 11b show exemplary diagrams of the Universal Mobile Telecommunications System (UMTS) packet network architecture.

### BEST MODE OF THE INVENTION

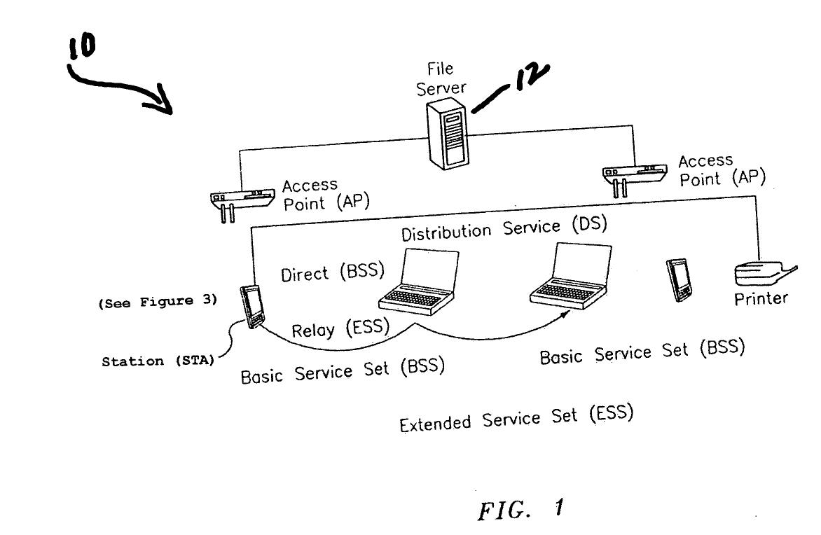

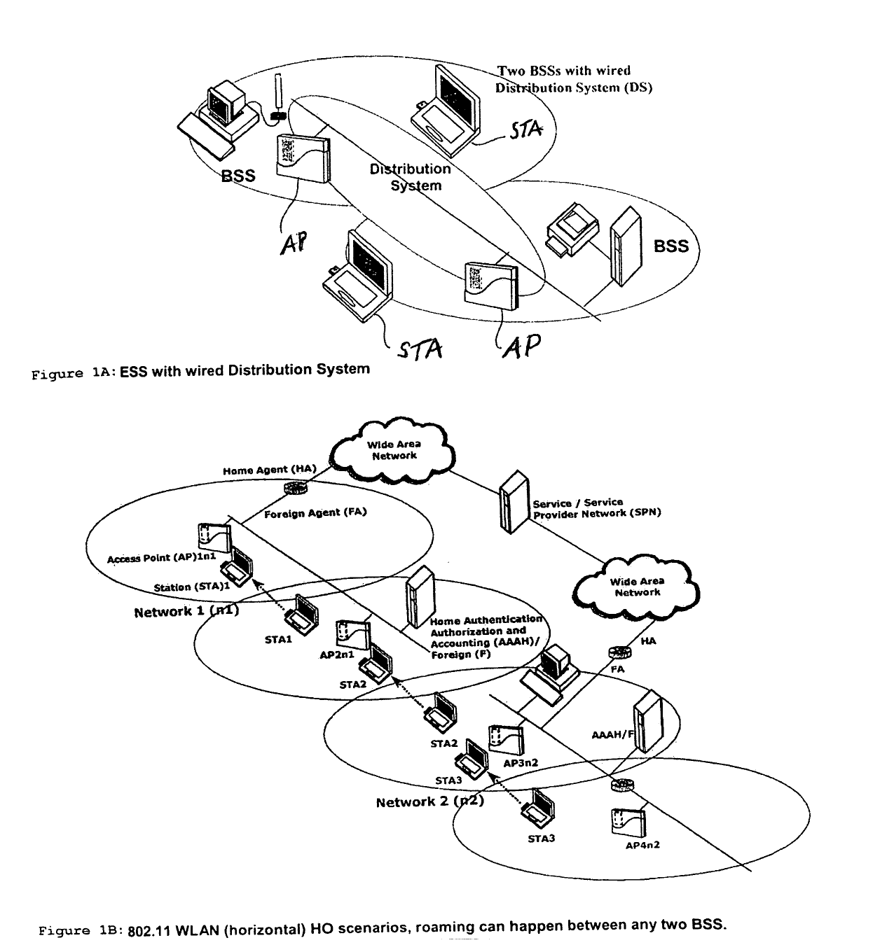

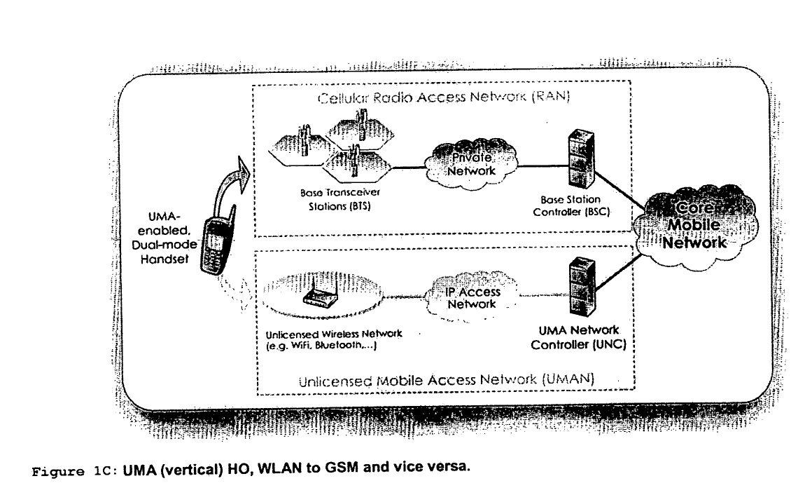

FIG. 1 shows, by way of example, an IEEE 802.11 WLAN system generally indicated as 10 in which the principles of the present invention are applicable, which provides for communications between communications equipment such as mobile and secondary devices including personal digital assistants (PDAs), laptops and printers, etc., as shown The WLAN system 10 may be connected to a wired LAN system that allows wireless devices to access information and files on a file server or other suitable device, such as 12, or connecting to the Internet. It is understood that a WLAN is a general term for a data communications network where radio waves function as the physical information carrier to the end user. Commonly, the WLAN is thought as an equivalent for Institute of Electrical and Electronics Engineers (IEEE) 802.11 family of WLAN standards. It should be noted, however, that the principles of the present invention are applicable also to other wireless short-range communication system standards, including, but not limited to: Bluetooth standard, High Performance Radio Local Area Network (HIPERLAN) standards and Ultra Wideband (UWB) standards.

In FIG. 1, the devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. The AP is typically an STA that acts as a communication hub for other STAs to connect to another (commonly IEEE 802) network. In such a WLAN system, end user access devices are known as stations (STAs), which include any device that implements the functionality of the 802.11 protocol (Medium Access Control (MAC) protocol, physical layer, and interface to the radio medium). In operation, the STAs are transceivers (transmitters/receivers) that convert radio signals into digital signals that can be routed to and from the communications device and connect the communications equipment to access points (APs) that receive and distribute data packets to other devices and/or networks. By way of example, the STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

The present invention provides a new and unique technique for detecting in a wireless short-range communication device, such as, for example a WLAN STA the trend in received signal strength based on one or more characteristics, e.g. received signal strength values and current time of their observation, by fitting a generalized linear model to the values. Based on the detected trend, three things can be inferred by the WLAN STA:

1) WLAN radio coverage available for the STA is strengthening,

2) WLAN radio coverage available for the STA is stationary, or

3) WLAN radio coverage available for the STA is weakening

In operation, the technique includes receiving signals from a node, point or terminal (such as an access point (AP)) in the wireless local area network (WLAN); and estimating in the WLAN station (STA) the trend in the received signal strength values and the current time of their observation related to the received signals that can be utilized to predict the reliable threshold for performing a handover. In effect, given current time and signal strength, the technique can be utilized to predict the threshold for the handover (HO). It should be noted, however, that the same principles are applicable also to other suitable wireless short-range communication systems.

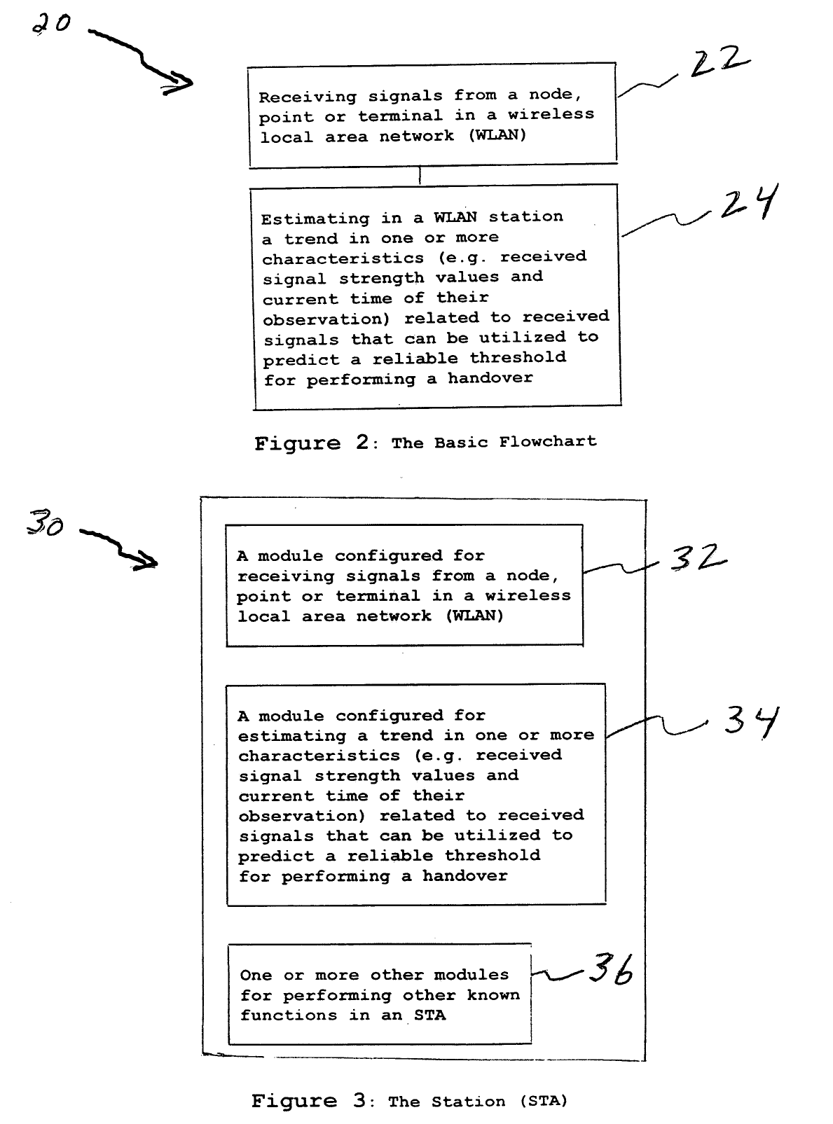

FIG. 2 shows a flowchart 20 having basic steps 22 and 24 of the method according to one embodiment of the present invention.

FIG. 3 shows the basic modules that make up the WLAN STA 30 or other suitable network node or terminal for operating in such a wireless LAN network 10 in FIG. 1 according to various embodiments of the present invention, including a module 32 configured for receiving signals from the node, point or terminal (such as the access point (AP)) in the wireless local area network (WLAN) and a module 34 configured for estimating in the WLAN station (STA) the trend in the received signal strength values and the current time of their observation related to the received signals that can be utilized to predict the reliable threshold for performing the handover. The WLAN STA 30 also includes one or more other modules for performing other known functions in the STA that are unrelated to the basic invention described herein.

The techniques provided by the various embodiments of the present invention may also be used in relation to the extended service set (ESS) shown in FIG. 1A, the 802.11 WLAN shown in FIG. 1B, and/or the unlicensed medium access (UMA) handoff, WLAN to GSM and vice versa shown in FIG. 1C, as well as other networks either now known or later developed in the future. In relation to that shown in FIGS. 1 to c, the following points are understood: A basic service set (BBS) is basic building block of WLAN network, consistent with that shown, for example, in FIGS. 1 and 1A. Within a BSS, a group of STAs communicate under control of a single MAC protocol coordination function. Radio coverage area provided by a BSS is called as Basic Service Area (BSA). An extended service set (ESS) is a set of two or more interconnected infrastructure BSSs forming a single network, consistent with that shown in FIG. 1A, while a distribution system (DS) is an element that connects BSSs within a given ESS. Distribution system can be either a wired or wireless connection. In the latter case, the APs function as wireless bridges between the BSSs.

### Roaming/Handover

For the purpose of understanding the present invention, a basic description of the terms “roaming” and “handover” as they are understood in the art are set forth below:

In telecommunications, roaming may have at least three different meanings, depending on the context:

1. A general term in wireless telecommunications that refers to the extension of connectivity service in a network that is different than the network with which a station is currently registered.

2. The ability of a WLAN STA user to travel from one BSS to another, with complete communications continuity.

3. A term given for inter-network operability, that is, moving from one network provider to another (internationally).

In comparison, a handover (HO) is understood to be a basic mobile network capability for support of terminal migration. HO management is the process of initiating and ensuring a seamless and lossless transfer of a data link connection of a STA, from one AP (or, more commonly, base station) to another. Furthermore, HOs can be divided to:
Vertical handover is a HO between two systems (such as WLAN-GSM), and
Horizontal handover is a HO within the same type of system (such as WLAN AP-AP).

For a WLAN HO, three separate scenarios are defined:

1. No-transition (STA is either static or mobile within a BSS),

2. an AP transition (handover from an AP to another (from BSS to another) within the same ESS), or

3. an ESS transition (STA HO from BSS to another where the BSSs belong to different ESSs).

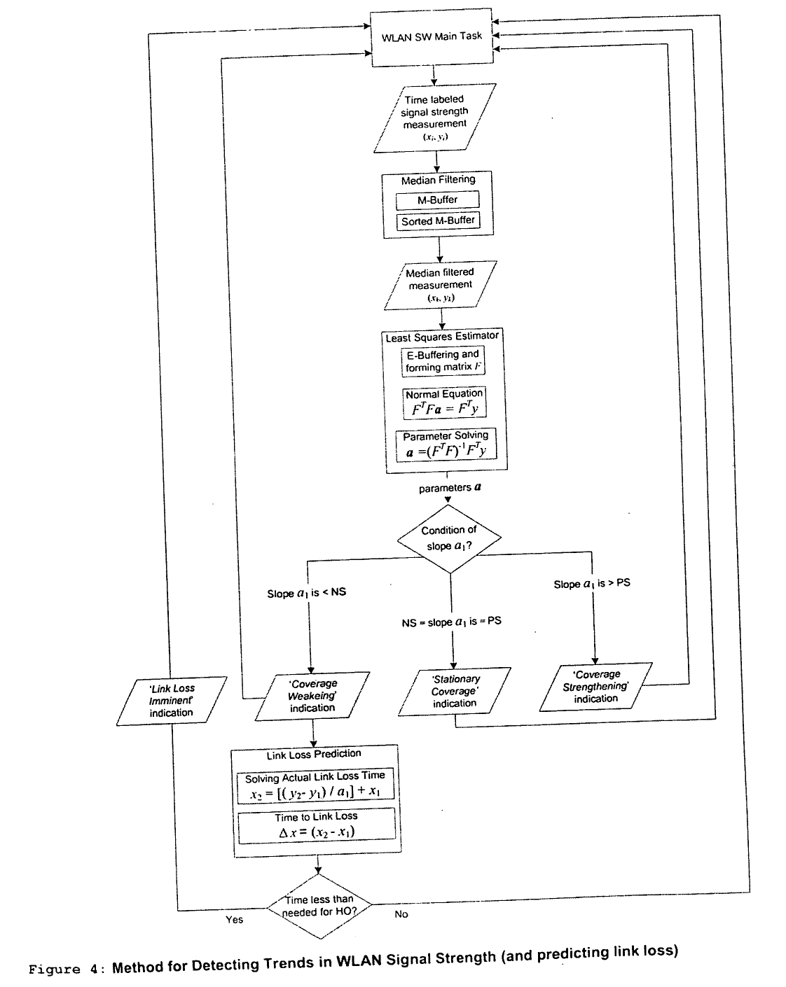

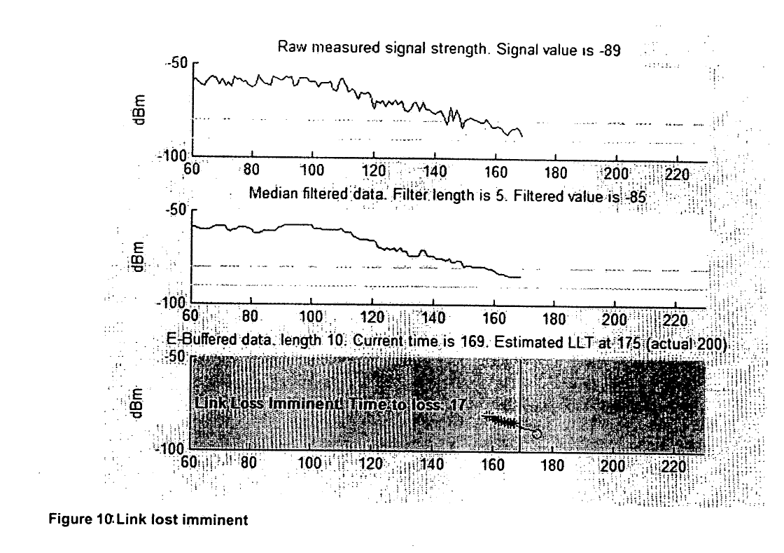

### FIGS. 4-10: Various Implementation Embodiments of the Present Invention

By way of example, FIGS. 4-10 set forth the basic implementation of the generalized linear model according to embodiments of the present invention.

FIG. 4 shows an actual “state machine” of the signal strength estimation according to one embodiment of the present invention. As can be seen from the “state machine”, the present invention provides an algorithm that can be used by a wireless short-range communication capable apparatus, such as, for example a WLAN mobile station to estimate/predict the trend in WLAN signal strength based on the received signal strength values and time of their observation by fitting the generalized linear model to the values. Based on the detected trend, three things can be inferred:

1. WLAN radio coverage available for the STA is strengthening

2. WLAN radio coverage available for the STA is stationary

3. WLAN radio coverage available for the STA is weakening.

### Given the current time and signal strength, the method according to the present invention can be utilized to predict a reliable threshold for performing a handover.

For example, the signal strength trend can be detected with an STA software (SW) implementation as follows:

1. From received MAC data frames, the received signal strength indication value (denoted here by yᵢ) can be read (either the Received Signal Strength Indicator (RSSI) or the Received Channel Power Indicator (RCPI), both discussed below).

2. A time stamp (denoted here by xᵢ) is attached for each received signal strength value;

3. A number (denoted here by M) of signal strength values are First In First Out (FIFO) buffered. This buffer is called herein the Median Buffer or M-Buffer;

4. The buffered data is median filtered, i.e. the M-Buffer is sorted and the median value is the filter output.

5. A number (denoted here by N) of median filtered data is FIFO buffered. This buffer is called the Estimator Buffer or E-Buffer herein.

6. For the data in the E-Buffer, the linear regression least square estimation fit is made and the linear fit parameters a₀ and a₁ are solved from a=(F^{T}F)⁻¹F^{T}y.

7. The condition (the absolute value and sign) of the fitted line slope a₁ is checked.

8. Based on the slope, three things can inferred:
a) if the slope is less than a certain predetermined parameter, Negative Slope (NS), the ‘Coverage Weakening’ indication is given
   the time for predicted link loss can be calculated by solving x₂ from a₁=(y₂−y₁)/(x₂−x₁). For y₂ one can use link loss threshold (LLT) that is predetermined and for y₁ the current value of median filtered data. For x₁ one can use the time stamp of last received signal strength value. x₂ (actual time for link loss) is the unknown in the equation and can be solved x₂=[(y₂−y₁)/a₁]+x₁. The predicted time □x for link loss is now known: □x=(x₂−x₁), and
   Link lost imminent indication is given when predicted link loss time is less than time known to be sufficient for vertical or horizontal HOs (which ever HO takes more time).
b) if the slope is in between of predetermined parameters, Negative Slope (NS) and Positive Slope (PS), the ‘Stationary Coverage’ indication is given.
c) if the slope is greater than a certain predetermined parameter, Positive Slope (PS), the ‘Coverage Strengthening’ indication is given.

### Receive Signal Strength Indicator (RSSI)

Consistent with that described above, it is noted that the IEEE 802.11 standard defines a mechanism by which RF energy is to be measured by the circuitry on a wireless STA. This numeric value is an integer with an allowable range of 0-255 (a 1-byte value) called the Receive Signal Strength Indicator (RSSI). Presently, 256 actual measurements of different signal levels are not taken, but known 802.11 implementation to have a specific maximum RSSI value (“RSSI Max”).

### Received Channel Power Indicator (RCPI)

Consistent with that described above, it is also noted that the RCPI indicator is a measure of the received RF power in the selected channel. This parameter shall be a measure by the PHY sublayer of the received RF power in the channel measured over the entire received frame. RCPI shall be a monotonically increasing, logarithmic function of the received power level defined in dBm. The allowed values for the Received Channel Power Indicator (RCPI) parameter may be an 8 bit value in the range from 0 through 220, with indicated values rounded to the nearest 0.5 dB, for example, as follows:

0: Power<−110 dBm

1: Power=−109.5 dBm

2: Power=−109.0 dBm

and so on where

RCPI=int{(Power in dBm+110)*2} for Odbm>Power>−110 dBm

220: Power>−0 dBm

221-254: Reserved

255: Measurement not available

Accuracy for each measurement shall be ±5 dB (95% confidence interval) within the specified dynamic range of the receiver. The measurement may assume a receiver noise equivalent bandwidth equal to the channel bandwidth multiplied by 1.1.

### Parameterization

For the method according to the present invention, and consistent with that described above, one or more of the following parameters may be used:

a) Signal strength measurement interval,

b) The length of the median filtering buffer,

c) The length of the estimator buffer,

d) The type of linear regression model and the number of its parameters, the estimation is valid for general linear function f(x,a)=a₁f₁(x)+ . . . +aₙfₙ(x). in the examples of this IPR first order polynomial f(x)=a₀+a₁x is used but some other model type, e.g. higher order polynomial f(x)=a₀+a₁x + . . . +aₙxⁿ could be considered as well,

e) The negative Slope (NS),

f) The positive Slope (PS),

g) The Link Loss Threshold,

h) Time needed for HO,

i) some combination thereof.

### Least Squares Estimator

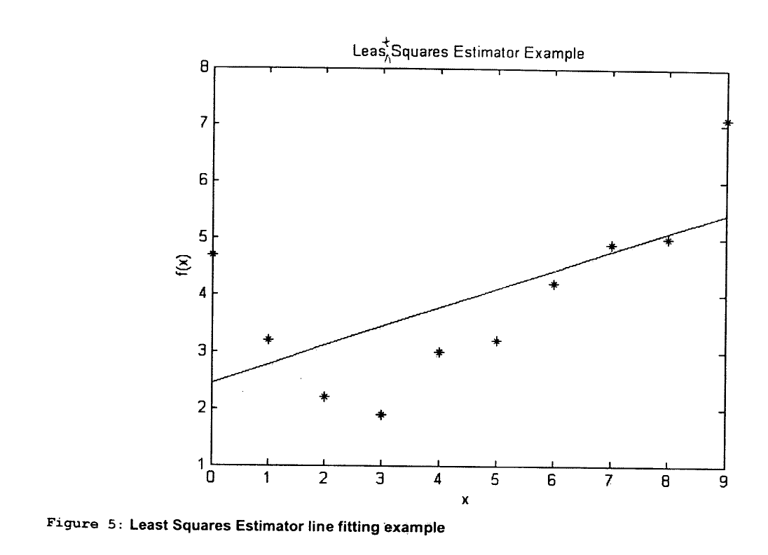

FIG. 5 shows an example of a least squares estimator that is described herein for the purpose of understanding the present invention. In the most general terms, least squares estimation is aimed at minimizing the sum of squared deviations of the observed values x for the dependent variable from those predicted by the model f(x). The goal of linear regression procedures is to fit a line through the points. Specifically, the estimator program can compute a line so that the squared deviations of the observed points from that line are minimized. Thus, this general procedure is sometimes also referred to as least squares estimation.

Let one denote a general linear function as f(x,a)=a₁f₁(x)+ . . . +aₙfₙ(x), where a is a function parameter and n is the degree of the function, and denote a set of given data points as (x₁, y₁), (x₂, y₂), . . . , (x_{N}, y_{N}) where y is the output and N is the number of data points. Now, minimizing the linear squares estimation function S(a)=Σ_{i=1 . . . N}(f(x₁,a)−y₁)² yields to a normal equation which we mark as F^{T}Fa=F^{T}y where i=1, . . . , N, and j=1, . . . , n. From the normal equation the function parameters a can be solved.

### Linear Equation

For the purpose of understanding the present invention, it is understood that a linear equation involves only the sum of constants or products of constants and the first power of a variable. Such an equation is equivalent to equating a first-degree polynomial to zero. A common form of a linear equation in two variables is f(x)=a₀+a₁x. In this form, the value a, will determine the slope or gradient of the line; and the value a₀ will determine the point at which the line crosses the y-axis. For any two data points (x₁, y₁), (x₂, y₂) slope of the line can be calculated: a₁=(y₂−y₁)/(x₂−x₁)=□y/□x.

Let one take an example for line fitting by least squares estimation, for data set of, as follows:

| | | | |
|---|---|---|---|
| F | a | = | y |

| | | | | |
|---|---|---|---|---|
| 1 | 0 | | = | 4.7 |
| 1 | 1 | | | 3.2 |
| 1 | 2 | | | 2.2 |
| 1 | 3 | | | 1.9 |
| 1 | 4 | a₀ | | 3 |
| 1 | 5 | a₁ | | 3.2 |
| 1 | 6 | | | 4.2 |
| 1 | 7 | | | 4.9 |
| 1 | 8 | | | 5 |
| 1 | 9 | | | 7.1 |

The minimization of the estimation function S(a) for the data set above yields to the following normal equation:

| | | | |
|---|---|---|---|
| F^{T}F | a | = | F^{T}y |

| | | | | |
|---|---|---|---|---|
| 10 | 45 | a₀ | = | 39.4 |
| 45 | 285 | a₁ | | 204.7 |

Solving the normal equation (a=(F^{T}F)⁻¹F^{T}y) in terms of a gives us a linear estimate f(x)=2.445+0.3321x for the exemplary data set.

### Median Filtering

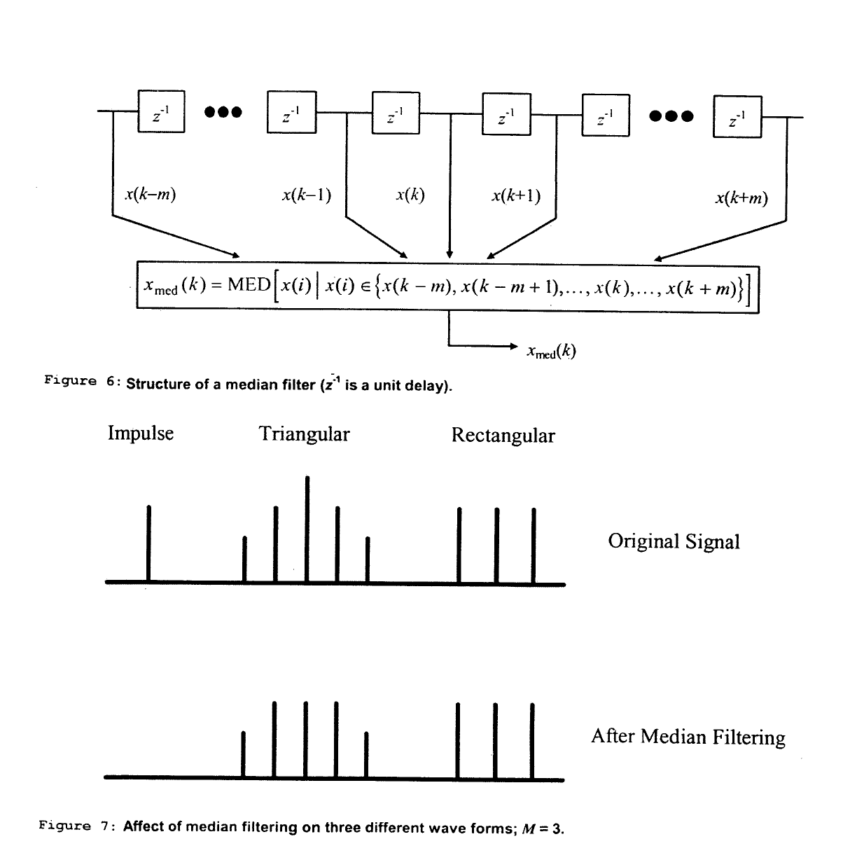

FIGS. 6-7 show the structure of a median filter and the affect of the median filtering on different waveforms.

For the purposes of understanding various embodiments of the present invention, it is understood that median filtering is a simple, non-linear operation, where the value of the signal x(k), k=1, 2, . . . , N is replaced with the median of the values within a window of fixed length M=2m+1. The window length defines how many samples will be used at a time for determining the median. M and m are positive integers and M is always odd. The median is both the (m+1)^{th} largest and (m+1)^{th} smallest element of a sorted set. All the samples of the signal are filtered by sliding a filter of the length Mthrough the original set.

In equation form, median filtering can be presented as follows:

x_{med}(k)=MED[x(i)|x(i)∈{x(k−m), x(k−m+1), . . . , x(k), . . . , x(k+m)}]

In order to filter the ends of the set in an appropriate way we must add m values to both the beginning and the end of the original set. The values to be added may be either zeros or similar to the first and last value of the set (fixed end values). Using the mirror images of the beginning and end of the signal is also possible.

Median filtering will remove the short (less than m+1 of length) outliers (impulses) from the signal preserving the longer lasting step-like changes.

Experiments have produced an exemplary estimation curve with a handover estimation compared to received signal strength data that indicate that a really good estimation for the trend of the received signal strength can be created to avoid unnecessary reactions to signal level differences of particular packets while providing necessary information for predicting becoming handover and an estimation of time when the becoming handover will be imminent.

### Advantages

The various embodiments of the present invention provides at least following advantages to a wireless short-range communication capable terminal, such as, for example a WLAN STA:

1) The STA power consumption is reduced and latencies in data transfer are smaller when, based on trend detection information, unnecessary scanning required for HO can be avoided.

2) There is an increased possibility to successfully roam the data link either to another system (vertical HO) or to another WLAN BSS (horizontal HO). The detection of weakening radio coverage gives an STA more time to search for new candidate networks and have an estimation when the link for existing network is lost.

3) The radio coverage of a WLAN AP is better utilized because there is no need to set the threshold of roaming unnecessarily high to give time for HO. An STA can stay longer in one BSS (i.e. stationary in weak radio coverage) because, based on the trend (i.e. user movement), HO can be predicted faster and more accurately than before.

4) The WLAN signal quality is improved when trend detection information is utilized for the adaptation of data transfer bit rate. When WLAN coverage is strengthening the data transfer bit rate can be increased and vice versa.

### EXAMPLE 1

If one assumes that the STA user is static within a BSA, and the measured signal strength varies between, say, −75 dBm and −85 dBm. However, the BER is still acceptable in these conditions, say, less than 10⁻⁵. Now, because the measurements are median filtered indicates less variation, say between −79 dBm and −81 dBm, and if the known link loss threshold is −90 dBm, the predicted link loss time is never less that the time needed for HO (say, 2 seconds) and the user can enjoy WLAN coverage further away from the AP that has been previously possible.

### EXAMPLE 2

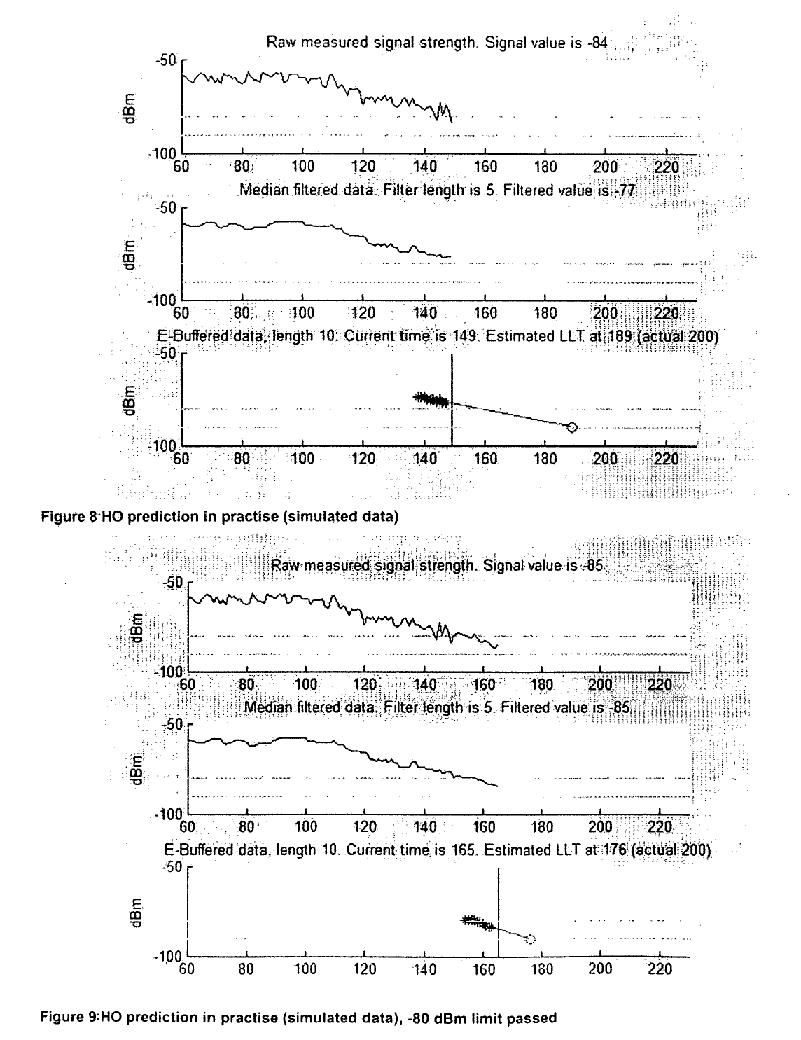

The STA user walks away from the AP she is currently connected to and the signal starts to degrade gradually. When the predicted link loss time is small enough ‘Link loss imminent’ indication is given and the HO is initiated in time to perform either horizontal or vertical HO. See, for example, that shown in FIGS. 8-10.

### Implementation of the Functionality of the Modules

The functionality of the STA 30 described above may be implemented in the modules 32 and 34 shown in FIG. 3. By way of example, and consistent with that described herein, the functionality of the module 32 and 34 may be implemented using hardware, software, firmware, or a combination thereof, although the scope of the invention is not intended to be limited to any particular embodiment thereof. In a typical software implementation, the module 32 and 34 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 32 and 34 being a stand alone modules, as shown, or in the combination with other circuitry for implementing another module.

The other module 36 and the functionality thereof are known in the art, do not form part of the underlying invention per se, and are not described in detail herein. For example, the other modules 36 may include other modules that formal part of a typical mobile telephone or terminal, such as a UMTS subscriber identity module (USIM) and mobile equipment (ME) module, which are known in the art and not described herein.

### 3GPP Network

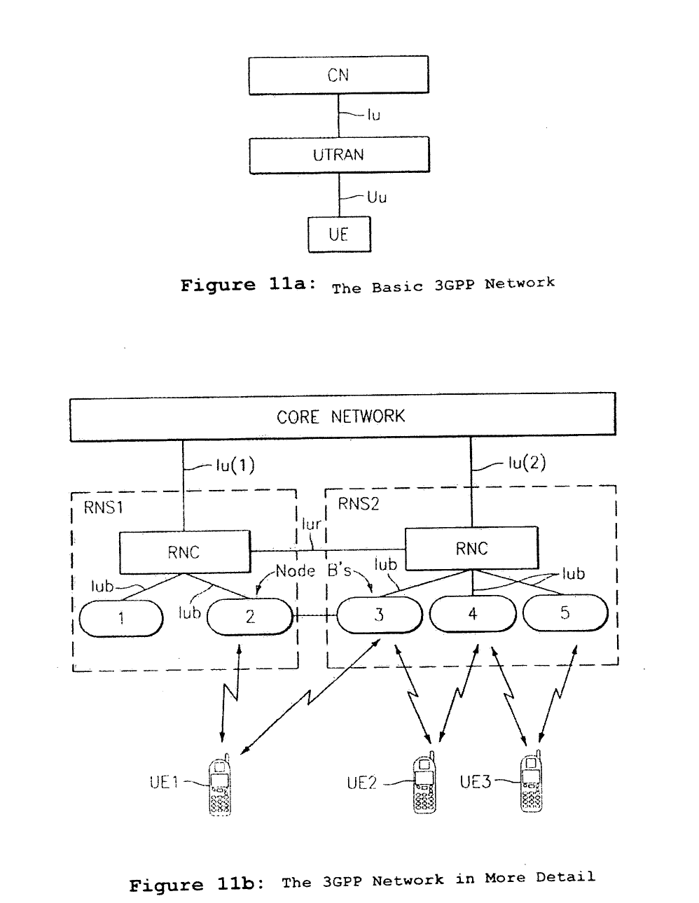

The interworking of the WLAN (IEEE 802.11) shown in FIG. 1 with such other technologies (e.g. 3GPP, 3GPP2 or 802.16) such as that shown in FIGS. 11a and 11b is being defined at present in protocol specifications for 3GPP and 3GPP2. The scope of the present invention is intended to include an implementation in relation to such an interworking.

By way of example, FIGS. 11a and 11b show diagrams of the Universal Mobile Telecommunications System (UMTS) packet network architecture, which is also known in the art. In FIG. 11a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) lu interface. FIG. 11b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 11a. A given UE may be in radio contact with multiple Node Bs even if one or more of the Node Bs are connected to different RNCs. For instance, a UE1 in FIG. 11b may be in radio contact with Node B2 of RNS1 and Node B3 of RNS2 where Node B2 and Node B3 are neighboring Node Bs. The RNCs of different RNSs may be connected by an lur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 11a and 11b has resulted in STAs taking the form of UEs, such as mobile phones or mobile terminals.

### Abbreviations

TABLE 1
List of abbreviations

| | |
|---|---|
| AP | Access Point |
| BER | Bit Error Rate |
| BSA | Basic Service Area |
| BSS | Basic Service Set |
| dBm | deciBels referred to 1 mW |
| DS | Distribution System |
| ESS | Extended Service Set |
| FIFO | First In First Out |
| GSM | Global System for Mobile communications |
| HO | HandOver |
| IEEE | Institute of Electrical and Electronics Engineers |
| MAC | Medium Access Control |
| MCU | Micro Controller Unit |
| PHY | Physical layer |
| RCPI | Received Channel Power Indicator |
| RF | Radio Frequency |
| RSSI | Received Signal Strength Indicator |
| STA | Station |
| SW | Software |
| UMA | Unlicensed Medium Access |
| WLAN | Wireless Local Area Network |

### SCOPE OF THE INVENTION

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method comprising:
receiving signals from a node, point or terminal in a wireless short-range communication network; and
estimating in a short-range communication device a trend in one or more characteristics related to the received signals that can be utilized to predict a reliable threshold for performing a handover.

2. A method according to claim 1, wherein the one or more characteristics include received signal strength values and current time of their observation.

3. A method according to claim 1, wherein the trend is based on fitting a generalized linear model to received signal strength values.

4. A method according to claim 1, wherein the short-range communication network is a wireless local area network (WLAN) and the short-range communication device is a WLAN mobile station (STA)

5. A method according to claim 4, wherein the trend is used to initiate a handoff event by the WLAN mobile station (STA).

6. A method according to claim 4, wherein the node, point or terminal is a WLAN access point (AP).

7. A method according to claim 4, wherein the trend includes one or more of the following determinations:
a) WLAN radio coverage available for a WLAN mobile station (STA) is strengthening,
b) the WLAN radio coverage available for the STA is stationary,
c) the WLAN radio coverage available for the STA is weakening, or
d) some combination thereof.

8. A method according to claim 1, wherein the signals comprise packets received by the short-range communication device.

9. A method according to claim 1, wherein actual calculations and the algorithm for determining an estimation of the trend of the signal strength values are based on performing median filtering for each measured signal strength.

10. A method according to claim 8, wherein a linear regression curve is created based on results of a least square estimation of the median filtering results.

11. A method according to claim 1, wherein the estimation of the trend is based on one or more of the following parameters:
a) the signal strength measurement interval,
b) the length of a median filtering buffer,
c) the length of an estimator buffer,
d) a type of linear regression model and the number of its parameters,
e) a negative slope (NS),
f) a positive slope (PS),
g) a Link Loss Threshold,
h) a time needed for a handoff (HO), or
i) some combination thereof.

12. A system comprising:
a node, point or terminal for providing signals in a wireless short-range communication network; and
a short-range communication device having a module configured for receiving the signals, and estimating a trend in one or more characteristics related to the signals that can be utilized to predict a reliable threshold for performing a handover.

13. A system according to claim 12, wherein the one or more characteristics include received signal strength values and current time of their observation.

14. A system according to claim 12, wherein the trend is based on fitting a generalized linear model to received signal strength values.

15. A system according to claim 12, wherein the short-range communication network is a wireless local area network (WLAN) and the short-range communication device is a WLAN mobile station (STA)

16. A system according to claim 15, wherein the trend is used to initiate a handoff event by the WLAN mobile station (STA).

17. A system according to claim 15, wherein the node, point or terminal is a WLAN access point (AP).

18. A system according to claim 15, wherein the trend includes one or more of the following determinations:
a) WLAN radio coverage available for a WLAN mobile station (STA) is strengthening,
b) the WLAN radio coverage available for the STA is stationary,
c) the WLAN radio coverage available for the STA is weakening, or
d) some combination thereof.

19. A system according to claim 12, wherein the signals comprise packets received by the short-range communication device.

20. A system according to claim 12, wherein actual calculations and the algorithm for determining an estimation of the trend of the signal strength values are based on performing median filtering for each measured signal strength.

21. A system according to claim 20, wherein a linear regression curve is created based on results of a least square estimation of the median filtering results.

22. A system according to claim 12, wherein the estimation of the trend is based on one or more of the following parameters:
a) the signal strength measurement interval,
b) the length of a median filtering buffer,
c) the length of an estimator buffer,
d) a type of linear regression model and the number of its parameters,
e) a negative slope (NS),
f) a positive slope (PS),
g) a Link Loss Threshold,
h) a time needed for a handoff (HO), or
i) some combination thereof.

23. A terminal, including a short-range communication device, comprising:
a first module configured for receiving signals from a node, point or terminal in a wireless short-range communication network; and
a second module configured for estimating a trend in one or more characteristics related to the received signals that can be utilized to predict a reliable threshold for performing a handover.

24. A terminal according to claim 23, wherein the one or more characteristics include received signal strength values and current time of their observation.

25. A terminal according to claim 23, wherein the trend is based on fitting a generalized linear model to received signal strength values.

26. A terminal according to claim 23, wherein the short-range communication network is a wireless local area network (WLAN) and the short-range communication device is a WLAN mobile station (STA)

27. A terminal according to claim 26, wherein the trend is used to initiate a handoff event by the WLAN mobile station (STA).

28. A terminal according to claim 26, wherein the node, point or terminal is a WLAN access point (AP).

29. A terminal according to claim 26, wherein the trend includes one or more of the following determinations:
a) WLAN radio coverage available for a WLAN mobile station (STA) is strengthening,
b) the WLAN radio coverage available for the STA is stationary,
c) the WLAN radio coverage available for the STA is weakening, or
d) some combination thereof.

30. A terminal according to claim 23, wherein the signals comprise packets received by the short-range communication device.

31. A terminal according to claim 23, wherein actual calculations and the algorithm for determining an estimation of the trend of the signal strength values are based on performing median filtering for each measured signal strength in order to level the signal strength values keeping them more “in-line” by reducing the significance of a particular measurement value for the estimation.

32. A terminal according to claim 31, wherein a linear regression curve is created based on results of a least square estimation of the median filtering results.

33. A terminal according to claim 23, wherein the estimation of the trend is based on one or more of the following parameters:
a) the signal strength measurement interval,
b) the length of a median filtering buffer,
c) the length of an estimator buffer,
d) a type of linear regression model and the number of its parameters,
e) a negative slope (NS),
f) a positive slope (PS),
g) a Link Loss Threshold,
h) a time needed for a handoff (HO), or
i) some combination thereof.

34. A computer program product with a program code, which program code is stored on a machine readable carrier, for carrying out the steps of a method comprising receiving signals from a node in a wireless short-range communication network; and estimating a trend in one or more characteristics, including received signal strength values and current time of their observation, related to the received signals that can be utilized to predict a reliable threshold for performing a handover, when the computer program is run in a module of a node, point or terminal, such as in a WLAN station (STA).
